(19) United States
(12) Patent Application Publication
(10) Pub. No.: US 2026/0291568 A1
(43) Pub. Date: Sep. 24, 2026

(54) Data-Driven Robust Beamforming

(71) Applicant: Telefonaktiebolaget LM Ericsson (publ), Stockholm (SE)

(72) Inventors: Joao Vieira, Hjärup (SE); Sai Subramanyam Thoota, Linköping (SE); Erik G. Larsson, Linköping (SE)

(21) Appl. No.: 19/474,774

(22) PCT Filed: Apr. 17, 2023
(86) PCT No.: PCT/SE2023/050348

§ 371 Date: Oct. 13, 2025

(51) Int. Cl. H04B 7/06

(52) U.S. Cl. CPC H04B 7/0617; H04B 7/0626; H04B 7/0639

(57) ABSTRACT

The present disclosure relates to a method performed by a node in a radio network, the method comprising obtaining initial channel state information, CSI; initiating selection of a first set of CSIs from a historic set of timestamped CSIs, the first set of CSIs being selected based on a criterion of similarity to the initial CSI; initiate determination of a second set of CSIs by including, for each of the CSIs in the first set, a sequence of CSIs consecutive in time comprising the respective CSI from the first set, the sequence being included from the historic set of timestamped CSIs; initiate generation of a set of beamforming vectors using the second set of CSIS, initiate transmission from the access node to the user device using the set of beamforming vectors.

The project leading to this application has received funding from the European Union's Horizon 2020 research and innovation program under grant agreement No. 101013425

### TECHNICAL FIELD

The present invention relates to a method in a node. In particular, to a method for robust beamforming.

### BACKGROUND

Massive multiple input multiple output (MIMO) technology is an integral part of the fifth generation (5G) standard and will continue to play a dominant role in future sixth generation communications as well. It provides large beamforming and spatial multiplexing gains to multiple users in a coverage area, which enables enhanced mobile broadband services and improves the network capacity as well. With the continuous increasing demand for several (emerging) wireless services with exceeding numbers of devices in both indoor and outdoor scenarios, such as virtual and extended reality, internet-of-things, etc., improving the performance of MIMO systems continues to be a fundamental problem.

A fundamental problem with downlink beamforming in a MIMO system is that one may not have access to very accurate channel state information (CSI) estimates at the transmitter, e.g., at a multi-antenna access point or transmit/receive point of a distributed MIMO system.

For example, in an environment with mobility, the CSI estimate may have been obtained some time ago, therefore delayed, such that the channel has changed significantly since the estimate was obtained. This reduces the beamforming gain if such outdated CSI estimate is used for beamforming. If the phase of the channel estimate is outdated, then the beamforming gain may be lost completely.

Beamforming with outdated CSI is a relevant problem in different types of applications, including:
1) wireless power transfer from antenna arrays to passive devices,
2) backscattering communication with zero-energy devices via multi-antenna emitters (and readers), and in
3) FDD DL MIMO communications where the time it takes to perform explicit DL channel estimation plus UE feedback plus DL precoder computation is comparable to the coherence time of the channel.

Conventional solutions to cope with this problem is for example using diversity transmission techniques (e.g., space-time codes). For example, if it is known that the estimate of the DL channel is outdated but its second-order statistics (covariance) matrix is known, then one can transmit a space-time code weighted by the dominant eigenvectors of this channel covariance matrix. However, this has the drawback that many channels are not well modeled only through second order statistics, and/or there may exist additional information at hand other than second order statistics that could be used, therefore rendering the approach ineffective.

Another conventional solution is to track channel subspaces and perform downlink, DL, beamforming using said tracked subspaces. For example, one such method is eigen-beamforming into a subspace spanned by the dominant eigenvectors of the channel covariance matrix. However, this has inferior performance in many cases because parameterization of the channel in terms of a linear subspace is not a good model in real scenarios.

As an extreme example, suppose the true channel is one out of two fixed, orthogonal channel vectors a and b. The subspace parameterization would then include any linear combination of a and b, which is a much larger set of vectors than the set of two vectors {a,b}.

Thus, there is a need for improved beamforming techniques.

At least one object of the invention is to overcome drawbacks/shortfalls of conventional solutions.

### SUMMARY OF THE INVENTION

The above-described drawbacks are overcome by the subject matter described herein. Further advantageous implementation forms of the invention are described herein.

According to a first aspect of the invention the object of the invention is achieved by a method performed by a node in a radio network, the method comprising obtaining initial channel state information, CSI, indicative of a channel between an access node and a user device of the radio network; initiating selection of a first set of CSIs from a historic set of timestamped CSIs, the first set of CSIs being selected based on a criterion of similarity to the initial CSI; initiating determination of a second set of CSIs by including, for each of the CSIs in the first set, a sequence of CSIs consecutive in time comprising the respective CSI from the first set, the sequence being included from the historic set of timestamped CSIs; initiating generation of a set of beamforming vectors using the second set of CSIs, wherein the number of beamforming vectors in the set of beamforming vectors is smaller than the number of CSIs in the second set; and initiating transmission from the access node to the user device using the set of beamforming vectors.

At least one advantage of the present disclosure according to the first aspect is improved beamforming gain and link robustness on downlink, DL, as a result of higher probability of illuminating a UE/user device in the presence of uncertainty in the CSI associated with the UE/user device.

In one embodiment of the first aspect, the method further comprises initiating detection of a trigger for the transmission from the access node to the user device.

In one embodiment of the first aspect, the method further comprises receiving a CSI comprising a timestamp and/or a geographical location and/or an estimate of a channel between the access node and the user device; and adding the received CSI to the historic set of timestamped CSIs.

In one embodiment of the first aspect, the initial CSI and the CSIs of the historic set of timestamped CSIs comprises a vector, wherein the criterion of similarity is indicative of a degree of alignment between a vector of the initial CSI and a vector of a CSI of the historic set of timestamped CSIs.

In one embodiment of the first aspect, the criterion of similarity comprises a normalized squared inner product between the two vectors.

In one embodiment of the first aspect, the criterion of similarity is defined as:

$${c}_{p} = \frac{{\vert {\hat{g}}^{H} {h}_{p} \vert}^{2}}{{‖ \hat{g} ‖}^{2} {‖ {h}_{p} ‖}^{2}}$$

where ĝ is the initial channel state information, hₚ is a candidate channel estimate from the historic set of timestamped CSIs, N is a number of CSIs in the historic set of timestamped CSIs and 1≤p≤N.

In one embodiment of the first aspect, the determination of the second set of CSIs comprises ordering the historic set by time, and for each CSI in the first set including k timestamped CSIs before and/or after the corresponding CSI of the first set.

In one embodiment of the first aspect, the determination of the second set of CSIs comprises including CSIs from the historic set having a geographical position falling within a window centered around a position of each CSI in the first set.

In one embodiment of the first aspect, the generation of the set of beamforming vectors comprises obtaining a candidate codebook; obtaining a list of sum beamforming gain using the candidate codebook for each CSI of the second set; selecting a CSI of the second set associated with the lowest sum beamforming gain; generating an improved codebook using the candidate codebook to maximize sum beamforming gain for the selected CSI.

In one embodiment of the first aspect, generating an improved codebook comprises applying a max-min optimization method.

According to a second aspect of the invention the object of the invention is achieved by a node in a radio network, the node comprising a processor, and a memory, said memory containing instructions executable by said processor, whereby said node is operative to obtain initial channel state information, CSI, indicative of a channel between an access node and a user device of the radio network; initiate selection of a first set of CSIs from a historic set of timestamped CSIs, the first set of CSIs being selected based on a criterion of similarity to the initial CSI; initiate determination of a second set of CSIs by including, for each of the CSIs in the first set, a sequence of CSIs consecutive in time comprising the respective CSI from the first set, the sequence being included from the historic set of timestamped CSIs; initiate generation of a set of beamforming vectors using the second set of CSIs, wherein the number of beamforming vectors in the set of beamforming vectors is smaller than the number of CSIs in the second set; initiate transmission from the access node to the user device using the set of beamforming vectors.

In an embodiment of the first aspect, said node is operative to perform the method according to the first aspect.

According to a third aspect of the invention the object of the invention is achieved by a computer program comprising computer-executable instructions for causing a computer, when the computer-executable instructions are executed on processing circuitry comprised in the computer, to perform the method according to the first aspect.

According to a fourth aspect of the invention the object of the invention is achieved by a computer program product comprising a computer-readable storage medium, the computer-readable storage medium having the computer program according to the third aspect embodied therein.

According to a fifth aspect a carrier containing the computer program according to the third aspect, wherein the carrier is one of an electronic signal, optical signal, radio signal, or computer readable storage medium.

The scope of the invention is defined by the appended claims.

### BRIEF DESCRIPTION OF THE DRAWINGS

It should be appreciated that like reference numerals are used to identify like elements illustrated in one or more of the figures.

FIG. 1 shows an example of a radio network.

FIG. 2 illustrates a concept of the disclosure according to one or more embodiments of the present disclosure.

FIG. 3 shows an example of a neighborhood selection.

FIG. 4 illustrates an example of expansion of the initial neighborhood channel list/first set of CSIs based on time.

FIG. 5 illustrates an example of expansion of the initial neighborhood channel list/first set of CSIs based on geographical location.

FIG. 6 shows a flowchart of a method according to one or more embodiments of the present disclosure.

FIG. 7A shows simulation results as beamforming gain related to a number of neighbors.

FIG. 7B shows simulation results as beamforming gain related to a metric.

FIG. 8 shows details of a network node according to one or more embodiments of the present disclosure.

A more complete understanding of embodiments of the invention will be afforded to those skilled in the art, as well as a realization of additional advantages thereof, by a consideration of the following detailed description of one or more embodiments. It should be appreciated that like reference numerals are used to identify like elements illustrated in one or more of the figures.

### DETAILED DESCRIPTION

The present disclosure relates to robust beamforming in a radio network. This is particularly relevant for wireless power transfer from antenna arrays to passive devices, backscattering communication with zero-energy devices via multi-antenna emitters, and in Frequency Division Duplex, FDD, downlink, DL, Multiple Input Multiple Output, MIMO, communications.

In other words, scenarios where channel state information, CSI, has a low reliability or is simply outdated. The CSI typically indicates channel properties of a communication link in a radio network.

Robust beamforming is particularly helpful in an environment when one or more access points, APs, or access nodes are deployed at distinct geographical locations, and users are typically moving between different APs.

In many cases, these users may be moving across similar trajectories, with some trajectory perturbations. In other words, the present disclosure of robust beamforming is particularly useful when users are frequently moving along regular or normal paths, with some deviations.

One primary deployment scenario could be indoors, for example machines provided with user devices and/or user equipment, UE, that are moving along paths inside a factory. A further example could be a forklift that moves around in a warehouse.

Robust beamforming is of concern during several phases of communication, including “regular” data transmission, and wireless power transfer and communication with passive devices.

Communication to passive devices often involves beamforming energy to a user device whose associated channel is only approximately known.

The present disclosure presents a solution to the robust beamforming problem in cases when there is a large amount of historical CSI available at the APs. Historical CSI may e.g., include direct UL channel measurements and/or DL channel measurements plus user-feedback. This historical CSI is then exploited to improve the radio link quality or beamforming gain to a set of estimated candidate locations indicative of where a UE or user device may be located. The primary idea or concept is to design a codebook of beamforming vectors, which will robustly transmit information and/or power to such a set of estimated candidate locations. To design suitable beamforming vectors, prior knowledge accumulated in the historical CSI is utilized.

Specifically, from historical CSI, a database of radio channel responses seen in the past can be formed. The entries in the database are preferably ordered in chronological order. I other words, each entry and/or radio channel response in the database is typically associated with a particular geographical location of the user and a particular timestamp. In other words, when and where a radio channel response was measured/established.

In one example, e.g., after a request for DL transmission is triggered, an initial CSI/a most recent CSI, e.g., comprising a recently measured channel estimate which might be slightly outdated, is fetched from the database, as well as other previously seen channel estimates that are “similar” to the most recently measured channel estimate.

With that, a set of responses that are “close” defined by a specific criterion of similarity is selected. E.g., using a distance measure for vectors. The distance measure defining a distance from the initial channel estimate to the other “similar” channel estimates.

Based on this selected set of responses, a set of beamforming vectors (termed “codebook” herein) is determined or generated by applying an optimization algorithm. This set of beamforming vectors may be designed according to, e.g., a minimax principle such that they are good for the “worst” among the set of channel responses. These beamforming vectors or beamformers are then used for downlink beamforming in a transmission to the user.

Note that the only input that are mandatory for the presently disclosed method is CSI, which is necessary to form the CSI database. Optional inputs to the disclosed method are timestamps indicative of when such CSI estimates were obtained and/or geographical location indicative of where such CSI estimates were obtained. The timestamps and/or geographical location are then associated to or comprised by each CSI entry in the database.

Even though the disclosure is sometimes described herein in the context of a single AP communicating with a single UE, the solution is equally applicable in any multi-antenna setup with one or multiple APs, either in a co-located or distributed MIMO deployment.

Advantages of the present disclosure includes improved beamforming gain and link robustness on DL due to higher probability of illuminating a UE/user device in the presence of uncertainty in the CSI associated with the UE/user device. Possible applications of the method include:
backscattering communications with an energy-neutral (passive) device, or
wireless power transfer to an energy-neutral device, or.

DL communications with high-mobility UEs in FDD bands, or
any other situation where the available channel estimate may be outdated.

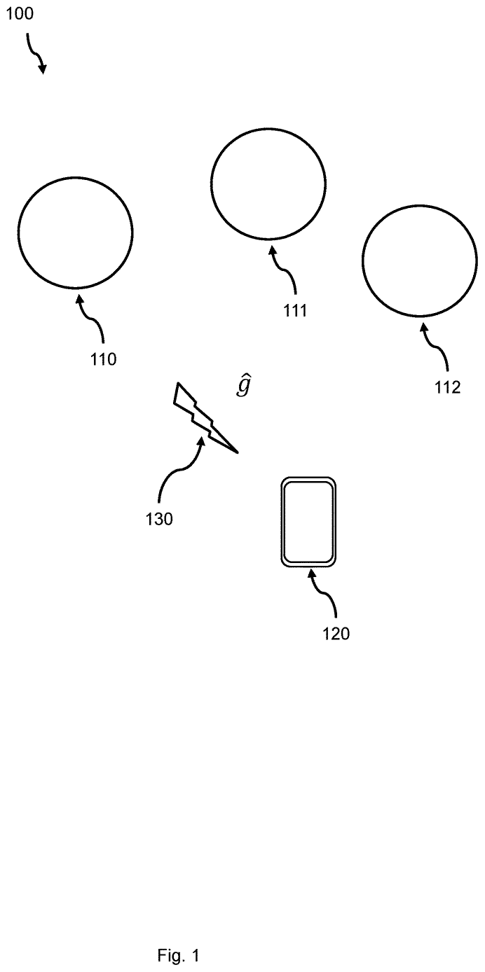

FIG. 1 shows an example of a radio network 100. The radio network comprises a plurality of nodes 110-112, 120. A particular type of node is an access node 110, which may comprise one or more antennas and circuitry capable of performing radio transmission 130. In one non-limiting example the nodes are radio access nodes 110-112 and/or user operated nodes 120, such as user equipment, UEs. Any other suitable nodes may be part of the radio network 100 without departing from the present disclosure.

A radio signal transmission 130 between nodes is then subjected to various effects represented by a radio channel. These effects are described by CSI, e.g., comprising a channel estimate.

In FIG. 1, a transmission 130 is made from an access node 110 to a user device 120, and the estimated CSI ĝ is stored in the database.

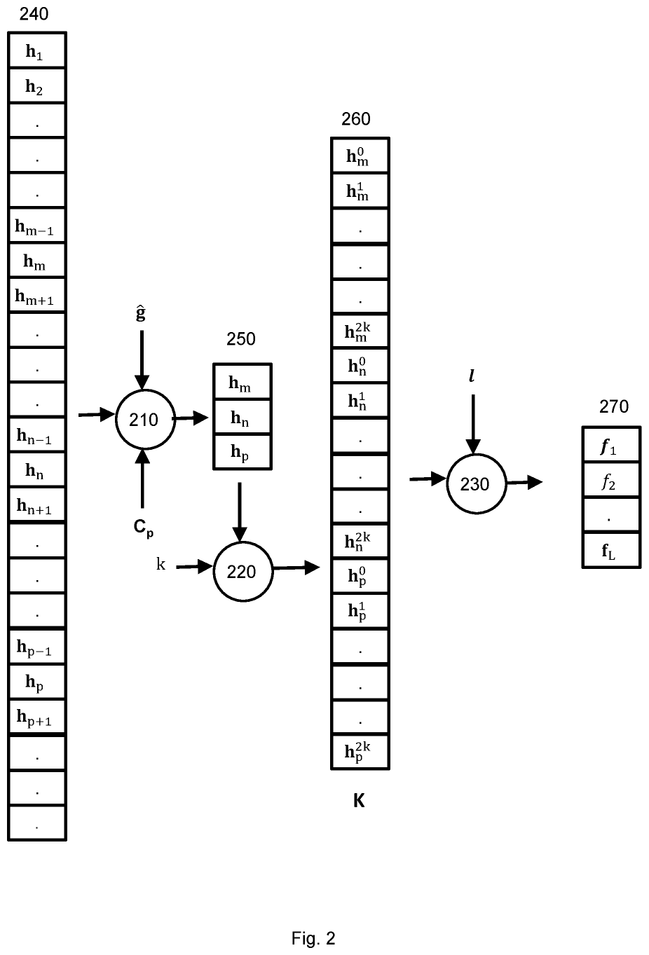

FIG. 2 illustrates a concept of the disclosure according to one or more embodiments of the present disclosure.

A historic set of CSIs 240 is maintained, e.g., in a database. The CSIs may optionally comprise timestamps and/or geographic locations associated to them. In other words, the time and location where the CSI was estimated is also recorded. The database may be located in any node of the radio network, e.g., the access node 110. A criterion of similarity cₚ is further maintained, e.g., as a predefined criterion of similarity cₚ.

In one example with reference to FIG. 1, the historic set of CSIs 240 may be generated in the following manner. We assume wireless communication, between an AP 110 and a user device/UE 120. The UE 120 traverses a three-dimensional path within a specified physical dimension, which creates a manifold of CSIs, e.g., comprising channel estimates such as channel vectors. The AP 110 repeatedly obtains CSI using one out of several possible approaches. For instance, in time-division duplexing, TDD, operation, it estimates the CSI using the pilots transmitted by the UE 120, either periodically or whenever there is a UL data transmission. There are multiple options to consider for pilot transmission depending on several factors such as the category of UEs, application scenarios, etc. Two of many available options are described herein, but any suitable method may be used without departing from the present disclosure.

Firstly, the UE 120 may transmit pilot symbols periodically at pre-defined instances.

Secondly, when the UE 120 has a grant to transmit UL data, it first transmits a pilot signal to aid in uplink, UL, decoding. This falls into the category of sporadic pilot transmission.

In another scenario of frequency-division-duplex, FDD, based systems, the AP 110 can obtain the CSI by having the UE 120 estimate the channel and use any feedback mechanism from the user, e.g., the type II CSI-feedback mechanism as in the New-Radio 5G standard.

As the AP 110 obtains CSI estimates, it stores them in a database, locally, in another node or in cloud storage. It can either store the complete CSI or extract features from the CSI and save only the relevant features.

As mentioned previously, The CSI may also optionally comprise a timestamp in the database which represents when the CSI was obtained and/or a geographical location which represents where the CSI was obtained. Some example features are:
(i) the angles-of-departure (AoD),
(ii) angles-of-arrival (AoA),
(iii) probability distributions of AoDs and AoAs.

In one example, the features of the CSI may be extracted using model-driven techniques such as subspace or Bayesian inference-based methods or extracted using data-driven procedures such as deep neural networks (DNNs). Other standard techniques to efficiently store data, such as those within the field of data compression, can be used to effectively use the available CSI storage space. For example, if several CSI estimates are very similar, the database may decide not to store all channel estimates to save storage room.

We denote the CSI dataset/historic set of CSIs 240, e.g., stored in the database, as [h₁ . . . hₚ]∈ [symbol] ^{M×N}, where M are the number of antennas at the AP 110 and N is the size of the stored CSI dataset (i.e., the number of CSIs stored), respectively. Each element in the dataset represents, corresponds to or is indicative of one channel obtained at a particular time-frequency resource, typically at a particular time and at a particular geographical position. If the mobility pattern of the UE/user device is such that it visits a vicinity of a particular point multiple times, then the channel responses in the database may have some structure, which is unknown a priori. In other words, there may be similarity or correlation between channels represented by elements in the historic set of CSIs 240.

In one example, a UE may travel around in an industrial factory environment multiple times following a repeated trajectory/path. Even though the path is “repeated” multiple times as the UE repeatedly follows the path, there can be minor variations, e.g., due to mechanical errors, which creates a “noisy trajectory”. Also, there will be variations in the radio environment. Hence, exactly the same channel responses may not be seen repeatedly when the UE travels along the trajectory/path, but rather, nearly the same channel response will be seen many times.

The database of stored CSI essentially represents a data-driven parameterization of the (a priori unknown) mapping between the three-dimensional physical space to an M-dimensional manifold of channel responses. The present disclosure utilizes this unknown mapping in a creative and novel way to improve the quality of the downlink transmission when applying beamforming.

This is achieved by obtaining an initial CSI @ indicative of a channel between the access node 110 and the user device 120 of the radio network 100. This is typically the latest CSI, e.g., DL CSI from the access node 110 and/or from the user device 120.

In embodiments, the step of obtaining of the initial CSI ĝ may optionally be initiated by a trigger. The AP 110 may in these embodiments check if there exists any trigger for DL operation from the access node 110 to the user device 120. Typical examples of such a trigger are requests for downlink data and/or wireless power transfer to a UE.

There are multiple ways to trigger the AP 110 to perform a DL transmission. In one example, the radio network 100 requests the AP to perform a DL transmission of data or power. In a further example, the UE may send a request in a control channel asking the network to serve it during the next available resources. As another example, in a scenario with energy-neutral devices, the UE can send a trigger based on its available energy level. One way to check whether a trigger has arrived at the AP is to keep polling at regular intervals. Once the AP 110 detects a trigger, it proceeds to the next step, else, it keeps polling and collects the received CSI in the database 240.

In one example, the AP receives a trigger for DL operation. The AP then retrieves an initial CSI ĝ from the database, e.g., comprising a channel estimate. Such an Initial CSI ĝ is typically indicative of the most recent channel estimate which was measured before the DL trigger was received. In one embodiment, the CSI could be obtained by using approximate location information, or by prediction in the database using timing information.

However, because of UE mobility, processing delays, and time between the DL trigger and the latest CSI measurement, this initial CSI ĝ can be outdated and therefore the usually optimal maximum-ratio transmit beamforming technique becomes sub-optimal.

The goal for the following steps of the disclosure is to intelligently combine the initial CSI @ with historic CSI 240 from the database to construct a “good set” of DL beamformers 270.

A first set of CSIs 250 is then selected 210 from the historic set of CSIs 240. The first set of CSIs is selected 210 based on a criterion of similarity to the initial CSI ĝ and uses the initial CSI ĝ and the historic set of CSIs 240 as input. The first set of CSIs 250 may e.g., be selected based on similarity of CSIs using channel estimates. In a non-limiting example, the CSIs each comprises a vector, and the criterion of similarity defines a degree of alignment between a vector of the initial CSI ĝ and a vector of a CSI of the historic set of CSIs 240. The criterion of similarity may e.g., comprise a normalized squared inner product between the two vectors.

In other words, we utilize the CSI database 240 to get a list of channel responses that are in some sense “neighbors” of g. In one example, a predefined number of CSIs, comprising channel vectors, are selected from the database that are close to the outdated CSI ĝ according to a specific a criterion of similarity cₚ.

We may denote the first set 250 of CSIs, comprising channel vectors, as the initial neighborhood channel list. Since such an initial neighborhood list comprises channel responses similar to g, it contains a suitable set of candidate channels to beamform towards considering the presence of uncertainty in ĝ. Once we get such an initial neighborhood channel list, we can use it to design beamforming vectors. However, the disclosure further attempts to factor in several further uncertainty factors, such as randomness in the UE mobility and randomness in the environment of the UE, when computing suitable beamforming vectors 270.

Hence, the initial neighborhood channel list 250 may be further expanded to account for such uncertainty factors. Also, it is known a priori that the UE behavior is most likely random. Therefore, we increase the length of the initial neighborhood channel list 250 by obtaining from the database a “local neighborhood” around each CSI in the initial neighborhood list 250. This results in a second larger set of CSIs 260.

In one example, the second set of CSIs 260 comprises a selection of:
1) the likely outdated initial CSI ĝ,
2) the initial neighborhood channel list/first set of CSIs 250 chosen from the entire historic set of CSIs 240, and
3) a local neighborhood list expanded around each member of the initial neighborhood list 250.

This total set of CSIs 260 comprising 1), 2) and 3) then serves as input to generation of beamforming vectors 270.

In other words, the initial neighborhood channel list/first set of CSIs 250, “similar” to the initial CSI ĝ is then expanded with “adjacent” CSIs, in some sense being adjacent to the initial neighborhood channel list/first set of CSIs 250 (see item 3 above). The local neighborhood list of CSIs may be adjacent in time and/or geographical location to members of the first set 250.

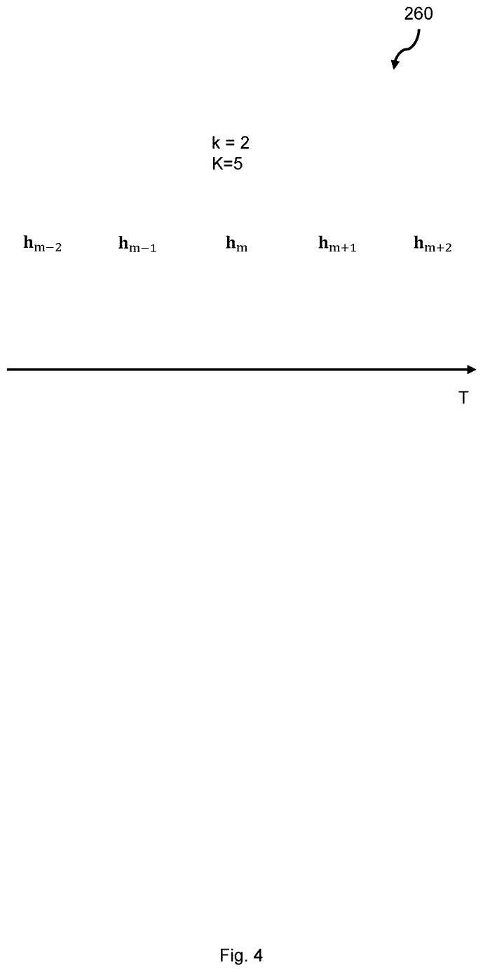

The determination of a second set of CSIs 260 may in one embodiment be determined by including, for each of the CSIs in the first set 250, a sequence of CSIs consecutive in time comprising the respective CSI from the first set, the sequence being included from the historic set of CSIs 240. In other words, sequences of reported CSIs when a UE is traversing a particular path is added to form a second set 260, the sequences including the first set of CSIs 250. This is further described in relation to FIG. 4.

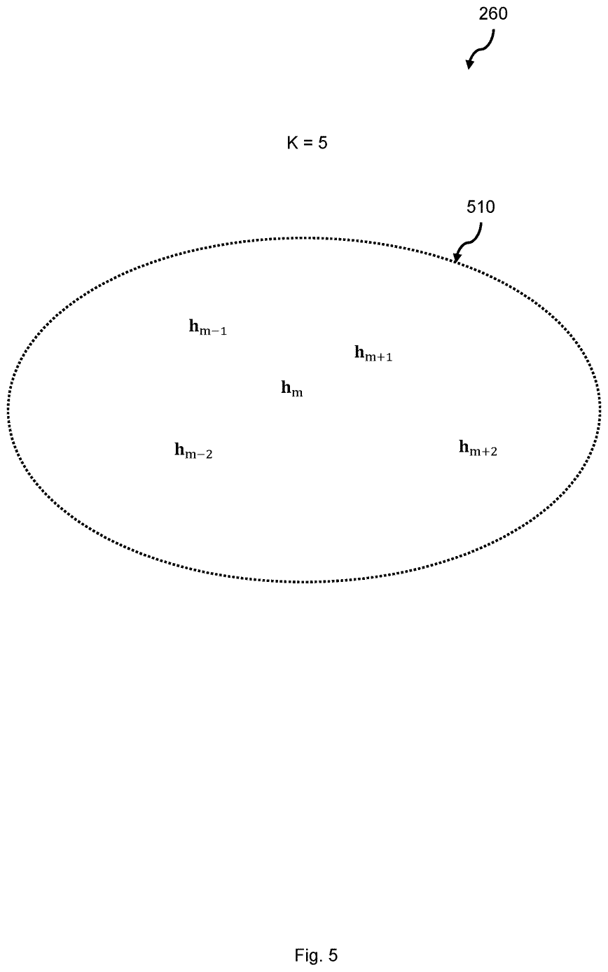

Additionally, or alternatively, the determination of a second set of CSIs 260 may in one embodiment be determined by including, for each of the CSIs in the first set 250, CSIs adjacent in space to the respective CSI from the first set, the sequence being included from the historic set of CSIs 240. In other words, CSIs associated with a geographical location within a predetermined distance from a respective CSI in the first set 250 are included in second set of CSIs 260. This is further described in relation to FIG. 5.

Referring again to FIG. 2, the historic set of CSIs 240 is used as input to a matching algorithm which selects 210 the initial neighborhood channel list/first set of CSIs 250 given the possibly outdated initial channel estimate ĝ and the criterion of similarity cₚ. Here, {m, n, p} are the indices of the selected entries from the historic set of CSIs 240 to form the initial neighborhood channel list/first set of CSIs 250. Only three selected indices are shown for illustration purposes, but the matching algorithm can choose any number of CSIs in the initial neighborhood channel list 250.

Then, the first set of CSIs 250 is used as input to a local neighborhood selection algorithm 220. We also optionally input a parameter k to the local neighborhood selection process 220. In embodiments, the initial neighborhood channel list/first set of CSIs 250 is expanded with a sequence of CSIs consecutive in time. E.g., a predefined number k of entries in the historic set of CSIs 240 before and/or after in time relative to a respective member of the initial neighborhood channel list/first set of CSIs 250. The k entries are included in the second set of CSIs 260. In other words, elements from the historic set of CSIs 240 are included to the second set of CSIs 260, which together with a respective element of the initial neighborhood channel list/first set of CSIs 250 form a sequence of CSIs consecutive in time, or having associated timestamps being ordered consecutive in time. This local neighborhood selection algorithm 220 may run as many times as the number of entries/elements in the initial neighborhood channel list 250.

In one example, in a first run of the local neighborhood selection algorithm 220, it picks the first index from the list (that is m) and goes to that index in the historic set 240. Then it picks k channels each before and/or after the m-th entry and places each one in a new expanded neighborhood list 260. Therefore, for each element from the initial neighborhood list, it picks 2k elements from the channel repository in total. This is illustrated in the right side of FIG. 2. Here, the subscripts indicate the elements in the initial neighborhood list and the superscripts represent the local neighborhood. For example,

$$\{ {h}_{m}^{0} , {h}_{n}^{0} , {h}_{p}^{0} \}$$

are the same as the initial neighborhood list {hₘ,hₙ,hₚ}, whereas

$$\{ {h}_{m}^{1} , … , {h}_{m}^{2 k} \}$$

are the expanded elements {hₘ₋ₖ,hₘ₋ₖ₊₁, . . . , hₘ₋₁,hₘ₊₁, . . . , hₘ₊ₖ₋₁,hₘ₊ₖ} from the historic set of CSIs 240. The local neighborhood selection algorithm 220 repeats this local neighborhood selection process for all the other elements in the initial neighborhood channel list/first set 250.

Finally, the output of this step is a total neighborhood channel list/second set of CSIs 260 which is at least of size 6 k+3 (=3*(2 k+1)) in the illustrated example.

In general, if the number of elements in the initial neighborhood list/first set 250 is P, then the maximum length of the total neighborhood channel list/second set is P*(2 k+1). Since there can be overlaps between the local neighborhoods associated with different elements in the initial list/first set 250, the length of the total neighborhood list/second set 260 can be smaller than P*(2 k+1).

In one embodiment, the indices P and k are chosen based on the uncertainty or a measure of uncertainty of the last channel response ĝ. For example, the values of the indices P and k are set proportionally to the time that has passed from the step of storing the initial channel estimate ĝ to the step of obtaining the initial channel estimate ĝ for use by the matching algorithm 210. In another embodiment, the parameter k may always be set equal to 1, or the number of elements in the initial neighborhood P may always be set equal to 1.

Any criterion of similarity may be used in the disclosed concept or method. In a preferred embodiment, a squared absolute value of the normalized inner product between the directions of the channel vectors is used as the metric to quantify how CSIs are “similar” and thereafter obtain the neighborhood list/first set 250. This metric is also known as the squared cos-angle between the vectors). Mathematically the criterion of similarity may in embodiments using channel representation as channel vectors be defined as,

$${c}_{p} = \frac{{\vert {\hat{g}}^{H} {h}_{p} \vert}^{2}}{{‖ \hat{g} ‖}^{2} {‖ {h}_{p} ‖}^{2}} \qquad ( 1 )$$

where cₚ is a measure of the distance between ĝ and hₚ, and pϵ[N]. This metric is an indicator of how aligned vectors g and hₚ are to each other. For example, if they fully aligned then cₚ equals 1, and if they are orthogonal then cₚ=0. The P channels with largest said metric values are chosen as the initial neighborhood.

In one example, the first set of CSIs 250 or the initial set of vectors chosen by the matching algorithm 210 is denoted by [hₘ, . . . , hₙ], where m and n are integers between 1 and N. Then, we include 2 k vectors around each member of the first set of CSIs 250 to get the final list/second set of CSIs 260, for some predetermined integer k. Without loss of generality, we denote the list of the latest CSI/initial CSI ĝ from the database and all the neighborhood channels by [h₁, . . . , h_{K}]. Note than the notation K used to define the total length of the neighborhood list 260 is different from the parameter k which is associated with the length of the local neighborhoods.

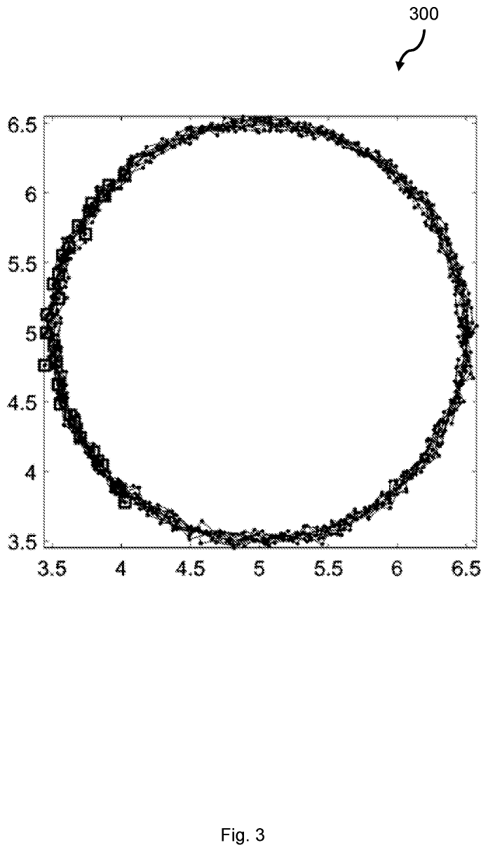

FIG. 3 shows an example 300 of the neighborhood selection 220. E.g., when a UE traverses through a noisy circular trajectory in an indoor environment of dimension 5 m×9 m×3.5 m. A single transmit antenna array with half wavelength spacing between its elements consisting of 825 elements is deployed on a wall with its center at the spatial coordinates [5 m, 0 m, 1 m]. The UE with one receive antenna is positioned at a height of 1 m. The carrier frequency is set to 2.4 GHz and the channel between the antenna array and the user undergoes a narrowband frequency-flat fading. The total length of the database is set to 1000 and the size of the initial neighborhood channel list 250 is chosen as 5. Around each of the 5 neighbors, we choose 10 local neighbors (5 on each side of the initial neighborhood channel list which means that the parameter k is set to 5) to get the total neighborhood channel list 260. The possibly outdated channel estimate ĝ is shown as a circle at 410 (x, y) coordinates ~(3.5, 5.1), and the total neighbor list 260 is shown in squares. Here there exist overlaps between the local neighbors of the elements in the initial neighborhood list, so the length of the total neighborhood list is less than 5*10+5.

Further, generation of a set of beamforming vectors 270 is initiated using the second set of CSIs 260, wherein the number of beamforming vectors in the set of beamforming vectors 270 is smaller than the number of CSIs in the second set.

In this generation step, a codebook of beamforming vectors 270 is constructed to be used for the DL transmission based on the second set of CSIs 260. Typical examples of optimization metrics are max-min-sum, max-min-min beamforming gains, etc. In a preferred embodiment, the maximum of the minimum total beamforming gain is optimized among all the channel responses in the second set/CSI neighborhood list 260. The present disclosure holds for any selected optimization criterion, not just max-min-min. Note that, if the exact CSI were known (e.g., ĝ equals the true channel), only one beamforming vector would be sufficient to maximize the beamforming gain (i.e., the complex conjugate of §). However, as mentioned before, in general ĝ differs from the true channel and the idea is then that channel responses in the neighborhood list are close to the true channel since the UE will likely be at a location close to some location that is has visited before, for which CSI is available in the second set of CSIs 260. Therefore, we design a codebook of L beamforming vectors which yields robustness of the beamforming process. We can then choose to beamform either with one or with many vectors from the codebook.

In one embodiment, an optimization problem used to generate the set of beamforming vectors 270 is defined as:

$$\begin{matrix}{P}_{0} : & {max}_{\{ {f}_{1} , … , {f}_{L} \} ϵ {ℂ}^{M \times L}} {min}_{k ϵ [ K ]}\end{matrix} \frac{{\sum }_{ℓ = 1}^{L} {\vert {h}_{k}^{H} {f}_{ℓ} \vert}^{2}}{{‖ {h}_{k} ‖}^{2}} \qquad ( 2 )$$

$$s . t . \qquad {‖ {f}_{ℓ} ‖}^{2} \leq {P}_{T} , ℓ ϵ [ L ] .$$

where P_{T} is the maximum transmit power constraint at the AP 110. fₗ is a beamforming vector. L is the number of beamforming vectors in the codebook. M is the number of transmit antennas. We now disclose a practical approach to optimize (2).

In one example, first, a list of the sum beamforming gain is obtained using a given codebook {f₁, . . . , f_{L}} for each of the K members in the channel list/second set of CSIs 260. Then, the list is sorted in ascending order. The first member of the order is selected. Essentially, this selects the weakest channel in the list for a given codebook of beamforming vectors. The codebook is then tweaked/adapted such that the sum beamforming gain is maximized for this weakest channel. A new codebook of beamforming vectors is then obtained, the sorting process repeated. Once again, the weakest channel in the list is selected and yet a new codebook is obtained. This process is repeated multiple times till the codebook does not change between successive iterations or the difference in result between iterations are below a threshold.

In one further embodiment, an optimization problem used to generate the set of beamforming vectors 270 is defined as:

$$\begin{matrix}{D}_{0} : & {max}_{\{ {f}_{1} , … , {f}_{L} \} ϵ {ℂ}^{M \times L}} {min}_{k ϵ [ K ]} {min}_{ℓ ϵ [ L ]}\end{matrix} \frac{{\vert {h}_{k}^{H} {f}_{ℓ} \vert}^{2}}{{‖ {h}_{k} ‖}^{2}}$$

$$s . t . \qquad {‖ {f}_{ℓ} ‖}^{2} \leq {P}_{T} , ℓ ϵ [ L ] .$$

In this embodiment, the minimum beamforming gain out of the L beamforming vectors is selected instead of the sum beamforming gain as the objective function. This ensures that the codebook of beamforming vectors give a uniform gain for the given channel list.

In one further embodiment, an optimization problem defines anon-convex maximization problem which does not have any closed-form analytical solution. To solve this problem, an equivalent formulation of P₀ is defined as:

$$\begin{matrix}{P}_{1} : & {max}_{{f}_{1} , … , {f}_{L} , t} t\end{matrix} \qquad ( 3 )$$

$$\begin{matrix}s . t . & \frac{{\sum }_{ℓ = 1}^{L} {\vert {h}_{k}^{H} {f}_{ℓ} \vert}^{2}}{{‖ {h}_{k} ‖}^{2}}\end{matrix} \geq t , k ϵ [ K ] \qquad ( 4 )$$

$${‖ {f}_{ℓ} ‖}^{2} \leq {P}_{T} , ℓ ϵ [ L ] . \qquad ( 5 )$$

A convex relaxation technique is applied on the non-convex constraint (4) and the resulting convex optimization problem is solved in an iterative manner. Two of the widely known approaches to relax a non-convex objective function or constraint are semidefinite relaxation (SDR) and successive convex approximation (SCA). The SCA method is adopted to demonstrate the data-driven robust beamforming design. Firstly, an initial set of L feasible points {w₁, . . . , w_{L}} is selected that satisfy the total power constraint, and convexify the constraints around them. The constraint (4) is then linearized using a Taylor series approximation of it as:

$$\begin{matrix}{\sum }_{ℓ = 1}^{L} {\vert {h}_{k}^{H} {f}_{ℓ} \vert}^{2} = {\sum }_{ℓ = 1}^{L} {f}_{ℓ}^{H} {h}_{k} {h}_{k}^{H} {f}_{ℓ} \\ \approx {\sum }_{ℓ = 1}^{L} ( 2 Rea l ( {f}_{ℓ}^{H} {h}_{k} {h}_{k}^{H} {w}_{ℓ} ) - {w}_{ℓ}^{H} {h}_{k} {h}_{k}^{H} {w}_{ℓ} )\end{matrix} \qquad ( 6 )$$

Substituting (6) in (4) and simplifying, the resulting optimization problem can be defined as:

$$\begin{matrix}{P}_{2} : & {max}_{{f}_{1} , … , {f}_{L} , t} t\end{matrix} \qquad ( 7 )$$

$$\begin{matrix}s . t . & {\sum }_{ℓ = 1}^{L} ( {w}_{ℓ}^{H} {h}_{k} {h}_{k}^{H} {w}_{ℓ} - 2 Real ( {f}_{ℓ}^{H} {h}_{k} {h}_{k}^{H} {w}_{ℓ} ) ) \leq - t {‖ {h}_{k} ‖}^{2} , k ϵ [ K ]\end{matrix} \qquad ( 8 )$$

$${‖ {f}_{ℓ} ‖}^{2} \leq {P}_{T} , ℓ ϵ [ L ] . \qquad ( 9 )$$

The convex problem P₂ is solved using a convex optimization solver to obtain its corresponding globally optimal solution. A set of beamforming vectors {f₁, . . . , f_{L}} is generated, they are substituted as the new {w₁, . . . , w_{L}}, and P₂ is solved. This is repeated in an iterative fashion until a suitable convergence criterion is satisfied. With a maximum transmit power constraint, it is guaranteed that this approach converges to a locally optimal solution of P₀. Once a codebook of beamforming vectors is generated, A DL transmission using the one or more beamforming vectors 270 can be performed in the allocated time frequency resources. Alternatively, the AP 110 can select any beamforming vector, of the one or more computed beamforming vectors 270, as well and transmit either the data or power using that selected beamforming vector. In other words, to initiate transmission from the access node 110 to the user device 120 using the set of beamforming vectors 270.

FIG. 4 illustrates an example of expansion of the initial neighborhood channel list/first set of CSIs 250 based on time. In FIG. 4 an initial neighborhood channel list/first set of CSIs 250 comprising a single element hₘ is shown for illustration purposes. However, it is understood that the initial neighborhood channel list/first set of CSIs 250 may comprise any number of elements without departing from the present disclosure.

The matching algorithm 210 produces a first set of CSIs comprising a single channel estimate hₘ selected as being similar to the initial channel estimate ĝ. As mentioned previously, the selection is based on a criterion of similarity cₚ. The local neighborhood selection algorithm 220 then selects a sequence of CSIs [hₘ₋₂, hₘ₋₁, hₘ, hₘ₊₁, hₘ₊₂] consecutive in time and comprising the single channel estimate hₘ from the historic set of CSIs 240. In other words, CSIs having associated timestamps immediately before and/or after an associated timestamp of hₘ are used to determine the second set 260 from the historic set of CSIs 240. In the example in FIG. 4 a parameter k=2 is used to include two CSIs immediately before [hₘ₋₂, hₘ₋₁] and two CSIs immediately after hₘ [hₘ₊₁, hₘ₊₂].

In other words, the first set 250 is expanded with the selected local neighborhood to form the second set 250 having a number K=5 elements.

FIG. 5 illustrates an example of expansion of the initial neighborhood channel list/first set of CSIs 250 based on geographical location. In FIG. 5 an initial neighborhood channel list/first set of CSIs 250 comprising a single element hₘ is shown for illustration purposes. However, it is understood that the initial neighborhood channel list/first set of CSIs 250 may comprise any number of elements without departing from the present disclosure.

The matching algorithm 210 produces a first set of CSIs comprising a single channel estimate hₘ selected as being similar to the initial channel estimate ĝ. As mentioned previously, the selection is based on a criterion of similarity cₚ. The local neighborhood selection algorithm 220 then determines the second set 260 by expanding the first set 250 with members [hₘ₋₂, hₘ₋₁, hₘ₊₁, hₘ₊₂] of the historic set of CSIs 240 having an associated geographical location falling within/under a distance threshold 510 of a geographical location associated with hₘ. The distance threshold 510 is illustrated by the two-dimensional and dotted ellipse in FIG. 5, however distance may be defined in any suitable manner and in any suitable number of dimensions.

In other words, CSIs having associated geographical locations adjacent to an associated geographical location of hₘ are used to determine the second set 260 from the historic set of CSIs 240. The number of elements in the second set 260 is then K=5 after the expansion. The concept described in relation to FIG. 2 is described in the form of a method below.

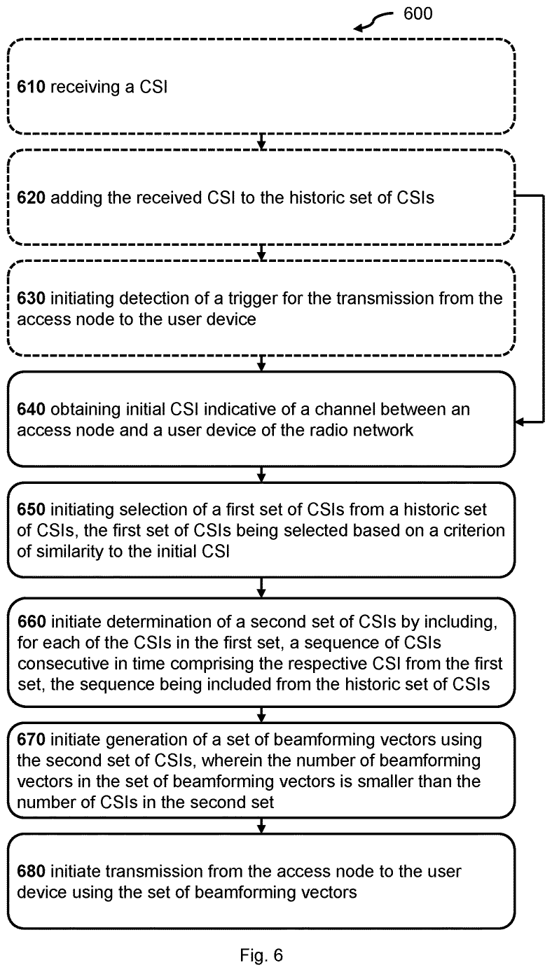

FIG. 6 shows a flowchart of a method 600 according to one or more embodiments of the present disclosure. The method is in embodiments a computer implemented method performed by a node in the radio network 100. The method comprises:

Step 640: obtaining initial CSI ĝ indicative of a channel between an access node 110 and a user device 120 of the radio network 100. In one example, the initial CSI ĝ comprises a channel estimate, optionally a channel vector. It is understood that CSI may comprise any suitable form for storing and processing information, e.g., arrays, tensors etc. in one example, the initial CSI ĝ is indicative of complex-valued baseband channels that the access node estimates fusing uplink pilots. It is understood that the access node has multiple antennas, and the initial CSI ĝ is indicative of one channel estimate per antenna, thus indicative of a vector of channel estimates.

In one further example, the initial CSI ĝ may instead be indicative of features/parameters of the channel estimates, such as angles of arrival, etc.

The channel estimates and/or features/parameters, may be timestamped/stored with timestamps indicative of when the estimate was established.

In one example, the initial CSI ĝ is obtained by estimating a channel by an access node 110 using pilot signals transmitted by a user device 120.

Step 650: initiating selection of a first set of CSIs 250 from a historic set of CSIs 240, the first set of CSIs being selected based on a criterion of similarity to the initial CSI ĝ. In one embodiment, each CSI of the historic set of CSIs 240 is timestamped. In other words, each element of the historic set 240 is associated to a timestamp indicative of when the CSI was obtained. Additionally, or alternatively, each CSI of the historic set of CSIs 240 is associated with a geographical location. In other words, each element of the historic set 240 is associated to a geographical location indicative of where the CSI was obtained, e.g., in the form of Global Positioning System, GPS, coordinates.

In one embodiment, the initial CSI ĝ and the CSIs of the historic set of CSIs 240 comprises a vector or channel vector, wherein the criterion of similarity is indicative of a degree of alignment between a vector of the initial CSI ĝ and a vector of a CSI of the historic set of timestamped CSIs 240.

Additionally, or alternatively the criterion of similarity comprises a normalized squared inner product between the two vectors.

Additionally, or alternatively the criterion of similarity is defined as:

$${c}_{p} = \frac{{\vert {\hat{g}}^{H} {h}_{p} \vert}^{2}}{{‖ \hat{g} ‖}^{2} {‖ {h}_{p} ‖}^{2}}$$

where ĝ is the initial channel state information, and, hₚ is a candidate channel estimate from the historic set of CSIs 240, N is a number of CSIs in the historic set of CSIs 240 and 1≤p≤N.

Step 660: initiate determination of a second set of CSIs 260 by including, for each of the CSIs in the first set, a sequence of CSIs consecutive in time comprising the respective CSI from the first set, the sequence being included from the historic set of CSIs 240.

Additionally, or alternatively, the determination of the second set of CSIs 260 comprises ordering the historic set 240 by time (using associated timestamps), and for each CSI in the first set 250 including k timestamped CSIs before and/or after the corresponding CSI of the first set 250. This is further described in relation to FIG. 4.

Additionally, or alternatively, the determination of the second set of CSIs 260 comprises including CSIs from the historic set 240 having a geographical position falling within a distance below a threshold, e.g., falling within a window, circle or other shape centered around a position of each CSI in the first set 250. This is further described in relation to FIG. 5.

In one example, the determination of the second set of CSIs 260 is performed by the local neighborhood selection algorithm 220 further described in relation to FIG. 2.

In one further example, the determination of the second set of CSIs 260 is performed by including a selection of the initial CSI ĝ, the first set 250 and CSIs from the historic set of timestamped CSIs 240 being adjacent to the CSIs in the first set 250. This is further described in relation to FIG. 2.

Step 670: initiate generation of a set of beamforming vectors 270 using the second set of CSIs, wherein the number of beamforming vectors in the set of beamforming vectors 270 is smaller than the number of CSIs in the second set 260.

Additionally, or alternatively, the generation of the set of beamforming vectors 270 comprises: obtaining a candidate codebook;
obtaining a list of sum beamforming gain using the candidate codebook for each CSI of the second set 260;
selecting a CSI of the second set 260 associated with the lowest sum beamforming gain; and
generating an improved codebook using the candidate codebook to maximize sum beamforming gain for the selected CSI.

Additionally, or alternatively, generating an improved codebook comprises applying a max-min optimization method.

Step 680: initiate transmission from the access node 110 to the user device 120 using the set of beamforming vectors 270. A single beamforming vector, a plurality of beamforming vectors or all the beamforming vectors of the set of beamforming vectors 270 may be used.

In one embodiment of the method 600, the method further comprises a step 630 of initiating detection of a trigger for the transmission from the access node 110 to the user device 120.

This step is performed before steps 640-680.

In one embodiment of the method 600, the method further comprises:

Step 610: receiving a CSI. In one embodiment the CSI comprises a selection of a timestamp and/or a geographical location and/or an estimate of a channel between the access node 110 and the user device 120.

Step 620: adding the received CSI to the historic set of timestamped CSIs 240. This may involve storing the CSI locally at the node, remote at another node or to store the CSI in cloud storage.

Steps 610-620 are performed before steps 610 and/or steps 640-680.

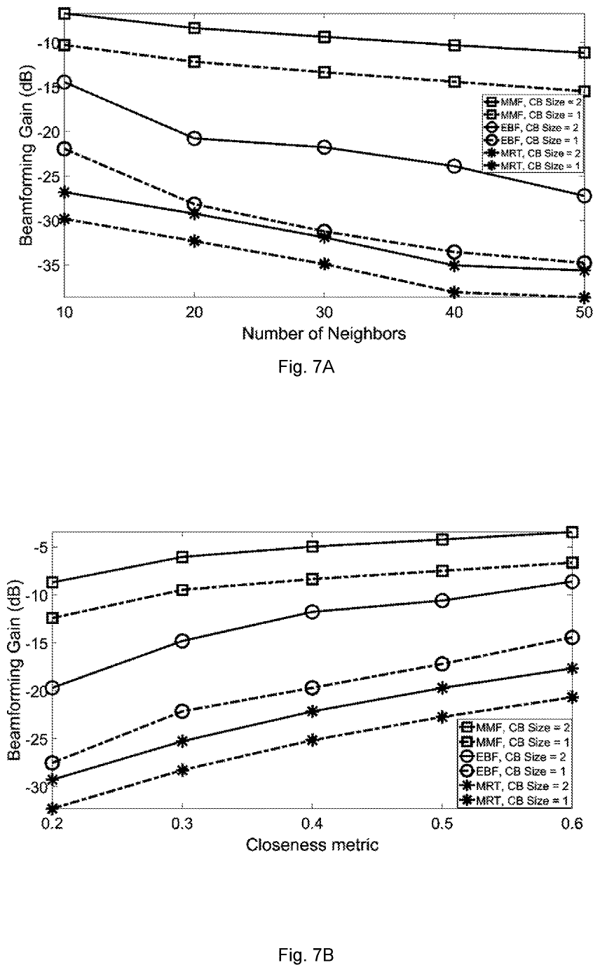

FIG. 7A shows simulation results as beamforming gain related to a number of neighbors.

FIG. 7A shows simulation results that demonstrate performance enhancements of the disclosed data driven robust beamforming solution. A beamforming gain of a codebook {f₁, . . . , f_{L}} is defined as:

$${min}_{k ϵ [ K ]} \frac{{\sum }_{ℓ = 1}^{L} {\vert {h}_{k}^{H} {f}_{ℓ} \vert}^{2}}{{‖ {h}_{k} ‖}^{2}}$$

A channel model that comprises deterministic and specular multipath components, SMC, and stochastic, diffuse/dense multipath components, DMC, is used in the simulation. Further details on the model can be found in the document B. J. B. Deutschmann, T. Wilding, E. G. Larsson and K. Witrisal, “Location-based Initial Access for Wireless Power Transfer with Physically Large Arrays,” 2022 IEEE International Conference on Communications Workshops (ICC Workshops), 2022.

The SMCs are modeled using an image source model to compute the positions of the image sources which contribute to the different multipath components. The DMC components are generated using a number of point scatterers which are uniformly distributed on the surface of an ellipsoid positioned in between the user and the transmit array. The semi-axes of the ellipsoid is [1.5 m, 0.5 m, 1.5 m]. The mean and standard deviation of the log-normally distributed point scatterer radar cross sections are chosen as 100π cm2 and 20π cm2, respectively. We set the number of point scatterers to 38 for illustration.

For simplicity in the simulations, the current channel is assumed to be one of the channel entries in the neighborhood list 260.

The total length of the historic set of CSIs 240 is set to 1000. In FIG. 7A, the length of the initial neighborhood channel list P/second set 260 is shown on the horizontal axis. The resulting beamforming gain is shown on the vertical axis.

FIG. 7B shows simulation results as beamforming gain related to a metric.

In 7B, a metric of the criterion of similarity is varied along the x-axis. As the metric increases, the number of CSIs selected from the historic set of CSIs 240 to form the neighborhood list/second set 260 decreases. For example, at a “closeness metric” of 0.6, all the elements from the historic set of CSIs 240 whose normalized squared inner product with the current outdated channel estimate is greater than 0.6 are selected to form the initial neighborhood channel list/first set 250. We choose a local neighborhood (parameter k=5) of length 10 around each of the elements in the initial neighborhood channel list 250. For illustration, we set the maximum transmit power constraint to 1. We show the results for the proposed max-min-fair, MMF, beamforming when the codebook sizes are set to 1 and 2, and for comparison, the results of two baseline solutions: eigen beamforming, EBF, and maximal-ratio transmit precoding, MRT.

MRT precoding denotes using the complex conjugate of the most recently measured channel estimate/initial channel estimate ĝ as the beamforming vector and pick the least gain after projecting it onto the complete neighbor channel list/second set 260. As the current channel can be any one of the neighboring channels, this essentially demonstrates the worst beamforming gain which can be achieved with MRT. When the codebook size is set to 2, we double the beamforming gain for MRT for fair comparison.

EBF demonstrates the performance when the beamforming vectors are chosen as the first one and two dominant eigenvectors of the sample covariance matrix of the neighborhood channel list for the codebook sizes of 1 and 2, respectively. The performance degradation compared to MMF is because, generally speaking, EBF focuses on maximizing a different cost function (average beamforming gain) and does not necessarily illuminate the weakest channel. MMF shows the performance of the max-min beamforming solution to the problem P₀. We choose the dominant eigenvectors of the sample covariance matrix as the initial points for the above-disclosed MMF optimization algorithm.

From the simulation results, it can be seen that the disclosed method consistently outperforms the other algorithms by a large margin. This shows that using the information of the stored channel database, together with suitable processing approaches, assists in obtaining a large beamforming gain and link robustness with is very desirable in applications that perform DL beamforming with uncertainty in the CSI.

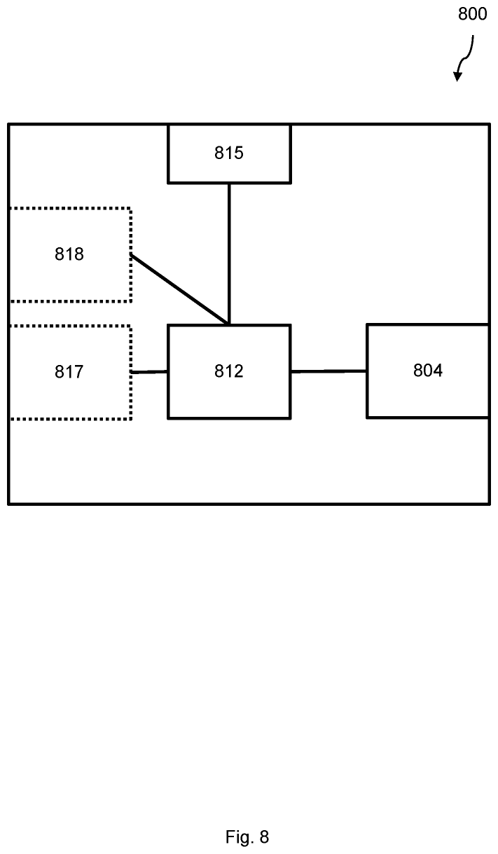

FIG. 8 shows details of a network node 800 according to one or more embodiments of the present disclosure.

The network node may be in the form of a selection of any of network node, a desktop computer, server, laptop, mobile device, a smartphone, a tablet computer, a smart watch etc. The network node may comprise processing circuitry 812. The network node may optionally comprise a communications interface 804 for wired and/or wireless communication. Further, the network node may further comprise at least one optional antenna (not shown in figure). The antenna may be coupled to a transceiver of the communications interface 804 and is configured to transmit and/or emit and/or receive wireless signals, e.g., in a wireless communication system.

In one example, the processing circuitry 812 may be any of a selection of processor and/or a central processing unit and/or processor modules and/or multiple processors configured to cooperate with each-other. Further, the network node may further comprise a memory 815. The memory 815 may contain instructions executable by the processing circuitry 812, that when executed causes the processing circuitry 812 to perform any of the methods and/or method steps described herein.

The communications interface 804, e.g., the wireless transceiver and/or a wired/wireless communications network adapter, is configured to send and/or receive data values or parameters as a signal to or from the processing circuitry 812 to or from other external nodes. In one embodiment, the communications interface 804 communicates directly between nodes or via a communications network.

In one or more embodiments the network node may further comprise an input device 817, configured to receive input or indications from a user and send a user-input signal indicative of the user input or indications to the processing circuitry 812.

In one or more embodiments the network node may further comprise a display 818 configured to receive a display signal indicative of rendered objects, such as text or graphical user input objects, from the processing circuitry 812 and to display the received signal as objects, such as text or graphical user input objects.

In one embodiment the display 818 is integrated with the user input device 817 and is configured to receive a display signal indicative of rendered objects, such as text or graphical user input objects, from the processing circuitry 812 and to display the received signal as objects, such as text or graphical user input objects, and/or configured to receive input or indications from a user and send a user-input signal indicative of the user input or indications to the processing circuitry 812.

In one or more embodiments the network node may further comprise one or more sensors (not shown).

In embodiments, the processing circuitry 812 is communicatively coupled to the memory 815 and/or the communications interface 804 and/or the input device 817 and/or the display 818.

In embodiments, the communications interface and/or transceiver 804 communicates using wired and/or wireless communication techniques.

In embodiments, the one or more memory 815 may comprise a selection of a hard RAM, disk drive, a floppy disk drive, a magnetic tape drive, an optical disk drive, a CD or DVD drive (R or RW), or other removable or fixed media drive.

In a further embodiment, the network node may further comprise and/or be coupled to one or more additional sensors (not shown) configured to receive and/or obtain and/or measure physical properties pertaining to the network node or the environment of the network node and send one or more sensor signals indicative of the physical properties to the processing circuitry 812.

It is to be understood that a network node comprises any suitable combination of hardware and/or software needed to perform the tasks, features, functions, and methods disclosed herein. Moreover, while the components of the network node are depicted as single boxes located within a larger box, or nested within multiple boxes, in practice, a network node may comprise multiple different physical components that make up a single illustrated component (e.g., memory 815 may comprise multiple separate hard drives as well as multiple RAM modules).

Similarly, the network node may be composed of multiple physically separate components, which may each have their own respective components.

The communications interface 804 may also include multiple sets of various illustrated components for different wireless technologies, such as, for example, GSM, WCDMA, LTE, NR, Wi-Fi, or Bluetooth wireless technologies. These wireless technologies may be integrated into the same or different chip or set of chips and other components within the network node. Processing circuitry 812 is configured to perform any determining, calculating, or similar operations (e.g., certain obtaining operations) described herein as being provided by a network node. These operations performed by processing circuitry 812 may include processing information obtained by processing circuitry 812 by, for example, converting the obtained information into other information, comparing the obtained information, or converted information to information stored in the network node, and/or performing one or more operations based on the obtained information or converted information, and as a result of said processing making a determination.

Processing circuitry 812 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node components, such as device readable medium, computer functionality. For example, processing circuitry 812 may execute instructions stored in device readable medium 815 or in memory within processing circuitry 812. Such functionality may include providing any of the various wireless features, functions, or benefits discussed herein. In some embodiments, processing circuitry 812 may include a system on a chip.

In some embodiments, processing circuitry 812 may include one or more of radio frequency, RF, transceiver circuitry and baseband processing circuitry. In some embodiments, RF transceiver circuitry and baseband processing circuitry may be on separate chips or sets of chips, boards, or units, such as radio units and digital units. In alternative embodiments, part or all of RF transceiver circuitry and baseband processing circuitry may be on the same chip or set of chips, boards, or units.

In certain embodiments, some or all the functionality described herein as being provided by a network node may be performed by the processing circuitry 812 executing instructions stored on device readable medium 815 or memory within processing circuitry 812. In alternative embodiments, some or all the functionalities may be provided by processing circuitry 812 without executing instructions stored on a separate or discrete device readable medium, such as in a hard-wired manner. In any of those embodiments, whether executing instructions stored on a device readable storage medium or not, processing circuitry 812 can be configured to perform the described functionality. The benefits provided by such functionality are not limited to processing circuitry 812 alone or to other components of network node but are enjoyed by the network node, and/or by end users.

The device readable medium or memory 815 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 812. Device readable medium 815 may store any suitable instructions, data, or information, including a computer program, software, an application including one or more of logic, rules, code, tables, etc. and/or other instructions capable of being executed by processing circuitry 812 and, utilized by network node. Device readable medium may be used to store any calculations made by processing circuitry 812 and/or any data received via interface 804. In some embodiments, processing circuitry 812 and device readable medium 815 may be considered to be integrated.

The communications interface 804 is used in the wired or wireless communication of signaling and/or data between network node and other nodes. Interface 804 may comprise port(s)/terminal(s) to send and receive data, for example to and from network node over a wired connection. Interface 804 also includes radio front end circuitry that may be coupled to, or in certain embodiments a part of, an antenna. Radio front end circuitry may comprise filters and amplifiers. Radio front end circuitry may be connected to the antenna and/or processing circuitry 812.

Examples of a network node may further include, but are not limited to an gNB, a gateway, a smart phone, a mobile phone, a cell phone, a voice over IP (VOIP) phone, a wireless local loop phone, a tablet computer, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc.

The communication interface 804 may encompass wired and/or wireless networks such as a local-area network (LAN), a wide-area network (WAN), a computer network, a wireless network, a telecommunications network, another like network or any combination thereof. The communication interface may be configured to include a receiver and a transmitter interface used to communicate with one or more other devices over a communication network according to one or more communication protocols, such as Ethernet, TCP/IP, SONET, ATM, optical, electrical, and the like). The transmitter and receiver interface may share circuit components, software, or firmware, or alternatively may be implemented separately.

In embodiments, the access node 110 may comprise all of the features described in relation to FIG. 8, or a subset of the features described in relation to FIG. 8.

In embodiments, the user device/UE 120 may comprise all of the features described in relation to FIG. 8, or a subset of the features described in relation to FIG. 8.

In one embodiment, a node in a radio network 100 is provided. The node comprises:
a processor, and
a memory, said memory containing instructions executable by said processor, whereby said node is operative to perform the method steps described herein.

In one embodiment, a computer program is provided and comprises computer-executable instructions for causing a computer, when the computer-executable instructions are executed on processing circuitry comprised in the computer, to perform the method described herein.

In one embodiment, a computer program product is provided and comprises a computer-readable storage medium, the computer-readable storage medium having the computer program according above embodied therein.

In one embodiment, a carrier containing the computer program above is provided. The carrier is one of an electronic signal, optical signal, radio signal, or computer readable storage medium.

Finally, it should be understood that the invention is not limited to the embodiments described above, but also relates to and incorporates all embodiments within the scope of the appended independent claims.

1-15. (canceled)

16. A method performed by a node in a radio network, the method comprising:
obtaining initial channel state information (CSI) indicative of a channel between an access node and a user device of the radio network;
initiating selection of a first set of CSIs from a historic set of timestamped CSIs, the first set of CSIs being selected based on a criterion of similarity to the initial CSI;
initiating determination of a second set of CSIs by including, for each of the CSIs in the first set, a sequence of CSIs consecutive in time comprising the respective CSI from the first set, the sequence being included from the historic set of timestamped CSIs;
initiating generation of a set of beamforming vectors using the second set of CSIs, wherein the number of beamforming vectors in the set of beamforming vectors is smaller than the number of CSIs in the second set; and
initiating transmission from the access node to the user device using the set of beamforming vectors.

17. The method according to claim 16, further comprising initiating detection of a trigger for the transmission from the access node to the user device.

18. The method according to claim 16, further comprising:
receiving a CSI comprising a timestamp and/or a geographical location and/or an estimate of a channel between the access node and the user device; and
adding the received CSI to the historic set of timestamped CSIs.

19. The method according to claim 16, wherein the initial CSI and the CSIs of the historic set of timestamped CSIs comprises a vector, wherein the criterion of similarity is indicative of a degree of alignment between a vector of the initial CSI and a vector of a CSI of the historic set of timestamped CSIs.

20. The method according to claim 19, wherein the criterion of similarity comprises a normalized squared inner product between the two vectors.

21. The method according to claim 20, wherein the criterion of similarity is defined as:
$${c}_{p} = \frac{{\vert {\hat{g}}^{H} {h}_{p} \vert}^{2}}{{‖ \hat{g} ‖}^{2} {‖ {h}_{p} ‖}^{2}}$$
where ĝ is the initial CSI, hₚ is a candidate channel estimate from the historic set of timestamped CSIs, N is a number of CSIs in the historic set of timestamped CSIs and 1≤p≤N.

22. The method according to claim 16, wherein the determination of the second set of CSIs comprises ordering the historic set by time, and for each CSI in the first set including k timestamped CSIs before and/or after the corresponding CSI of the first set.

23. The method according to claim 16, wherein the determination of the second set of CSIs comprises including CSIs from the historic set having a geographical position falling within a window centered around a position of each CSI in the first set.

24. The method according to claim 16, wherein the generation of the set of beamforming vectors comprises:
obtaining a candidate codebook;
obtaining a list of sum beamforming gain using the candidate codebook for each CSI of the second set;
selecting a CSI of the second set associated with the lowest sum beamforming gain;
generating an improved codebook using the candidate codebook to maximize sum beamforming gain for the selected CSI.

25. The method according to claim 24, wherein generating an improved codebook comprises applying a max-min optimization method.

26. A node in a radio network, the node comprising:
a processor, and
a memory, said memory containing instructions executable by said processor, whereby said node is operative to:
obtain initial channel state information (CSI) indicative of a channel between an access node and a user device of the radio network;
initiate selection of a first set of CSIs from a historic set of timestamped CSIs, the first set of CSIs being selected based on a criterion of similarity to the initial CSI;
initiate determination of a second set of CSIs by including, for each of the CSIs in the first set, a sequence of CSIs consecutive in time comprising the respective CSI from the first set, the sequence being included from the historic set of timestamped CSIs;
initiate generation of a set of beamforming vectors using the second set of CSIs, wherein the number of beamforming vectors in the set of beamforming vectors is smaller than the number of CSIs in the second set; and
initiate transmission from the access node to the user device using the set of beamforming vectors.

27. A non-transitory computer readable medium storing computer program instructions that, when executed by a processor of a network node associated with an access node of a radio network, configure the network node to:
obtain initial channel state information (CSI) indicative of a channel between the access node and a user device of the radio network;
initiate selection of a first set of CSIs from a historic set of timestamped CSIs, the first set of CSIs being selected based on a criterion of similarity to the initial CSI;
initiate determination of a second set of CSIs by including, for each of the CSIs in the first set, a sequence of CSIs consecutive in time comprising the respective CSI from the first set, the sequence being included from the historic set of timestamped CSIs;
initiate generation of a set of beamforming vectors using the second set of CSIs, wherein the number of beamforming vectors in the set of beamforming vectors is smaller than the number of CSIs in the second set; and
initiate transmission from the access node to the user device using the set of beamforming vectors.
